(19) United States
(12) Patent Application Publication
(10) Pub. No.: US 2016/0031300 A1
(43) Pub. Date: Feb. 4, 2016

(54) SUNROOF DRAIN DEVICE

(71) Applicant: AISIN SEIKI KABUSHIKI KAISHA, Kariya-shi (JP)

(72) Inventors: Shintaro KATSURA, Novi, MI (US); Ryuta FUKADA, Kariya-shi (JP)

(73) Assignee: AISIN SEIKI KABUSHIKI KAISHA, Kariya-shi (JP)

(21) Appl. No.: 14/809,537

(22) Filed: Jul. 27, 2015

(30) Foreign Application Priority Data
Jul. 31, 2014 (JP) 2014-156638

(51) Int. Cl. B60J 7/00; B60J 7/043

(52) U.S. Cl. CPC B60J 7/0084; B60J 7/043

(57) ABSTRACT

A sunroof drain device includes: a guide rail in which a drain portion is formed running in a longitudinal direction, and extends in the longitudinal direction; and a drain member which is disposed while being in contact with a rear end of the guide rail, in which upper and lower walls are formed with the guide rail interposed therebetween in a vertical direction, and through which the drain portion is connected to a drain hose. An engaging concave portion is formed in one of the guide rail and the drain member, and is concave in the vertical direction. An engaging convex portion is formed in the other of the guide rail and the drain member, protrudes in the vertical direction, and is engaged into the engaging concave portion such that the engaging convex portion restricts the drain member from moving toward the rear.

### CROSS REFERENCE TO RELATED APPLICATIONS

This application is based on and claims priority under 35 U.S.C. §119 to Japanese Patent Application 2014-156638, filed on Jul. 31, 2014, the entire contents of which are incorporated herein by reference.

### TECHNICAL FIELD

This disclosure relates to a sunroof drain device.

### BACKGROUND DISCUSSION

In the related art, JP 2010-47225A (refer to FIG. 1) (Reference 1) discloses a sunroof drain device. As illustrated in FIG. 6, this drain device includes a guide rail 90, in which a drain portion 91 is formed running in a longitudinal direction of a vehicle, and extends in the longitudinal, and a rear piece 95 that is attached to a rear end portion of the guide rail 90. The rear piece 95 connects the guide rail 90 to a drain hose (not illustrated), and drains water (for example, rain), flowing through the drain portion 91, to the outside of the vehicle via the drain hose.

Typically, the attachment of the rear piece 95 to the rear end portion of the guide rail 90 is performed by tightening screws or the like. Screws are required, and thus the number of components is increased.

### SUMMARY

Thus, a need exists for a sunroof drain device which is not suspectable to the drawback mentioned above.

A sunroof drain device according to an aspect of this disclosure includes a guide rail in which a drain portion is formed running in a longitudinal direction of a vehicle, and extends in the longitudinal direction; and a drain member which is disposed while being in contact with a rear end of the guide rail, in which an upper wall and a lower wall are formed with the guide rail interposed therebetween in a vertical direction of the vehicle, and through which the drain portion is connected to a drain hose, in which an engaging concave portion is formed in one of the guide rail and the drain member, and is concave in the vertical direction of the vehicle, and in which an engaging convex portion is formed in the other of the guide rail and the drain member, protrudes in the vertical direction of the vehicle, and is engaged into the engaging concave portion such that the engaging convex portion restricts the drain member from moving toward the rear of the vehicle relative to the guide rail.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view illustrating an embodiment of this disclosure;

FIGS. 2A to 2C are sectional views taken along line 2A-2A, line 2B-2B, and 2C-2C in FIG. 1, respectively;

FIG. 3 is a perspective view when a guide rail is seen from a rear top side of a vehicle;

FIG. 4 is a sectional view taken along line 4-4 in FIG. 1;

FIG. 5 is a plan view illustrating the embodiment; and

FIG. 6 is a plan view illustrating an embodiment in the related art.

### DETAILED DESCRIPTION

Hereinafter, an embodiment of a sunroof drain device will be described. In the following description, a “longitudinal direction” refers to a longitudinal direction of a vehicle, and an “upper side” and a “lower side” refer to the upper side and the lower side of the vehicle in a vertical direction of the vehicle, respectively. An inside, facing a vehicle's passenger compartment, in a lateral direction of the vehicle refers to the “inside of the vehicle”, and an outside, facing the outside of the vehicle's passenger compartment, in the lateral direction of the vehicle refers to the “outside of the vehicle”.

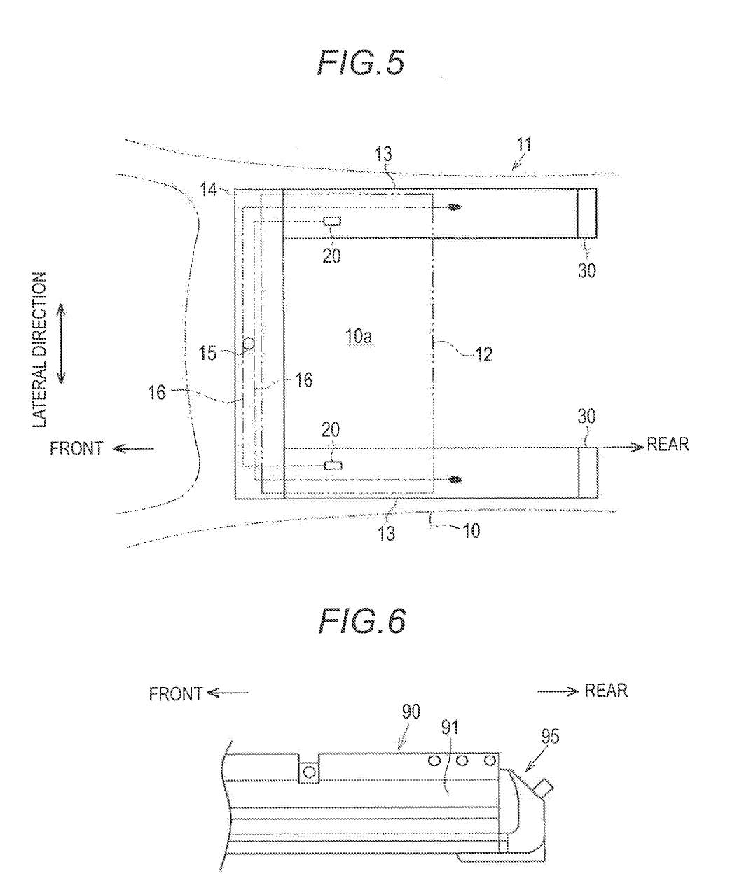

As illustrated in FIG. 5, a substantially rectangular opening 10a is formed in a roof 10 of a vehicle such as an automobile, and a sunroof apparatus 11 is mounted on the roof 10. The sunroof apparatus 11 includes a substantially rectangular movable panel 12 made of a glass plate or the like, which moves in the longitudinal direction to open or close the opening 10a.

The sunroof apparatus 11 further includes a pair of guide rails 13 that is provided in both edge portions of the opening 10a in the lateral direction of the vehicle. For example, the guide rail 13 is made of an extruded aluminum alloy material, and the guide rail 13 extends in the longitudinal direction with a uniform longitudinal section. Each of the guide rail 13 guides and supports a functional component 20 in such a manner that the functional component 20 can move in the longitudinal direction. The movable panel 12 is connected to and is supported by both the functional components 20 while being suspended therebetween. When both the functional components 20 move along the guide rails 13 in the longitudinal direction, the movable panel 12 is opened and closed.

Front ends of both the guide rails 13 are connected to each other via a front housing 14 that extends in the lateral direction of the vehicle. An electric driving source 15 with an output gear and the like is installed in a longitudinal intermediate portion of the front housing 14. The electric driving source 15 is connected to both of the functional components 20 via a pair of substantially belt-like driving belts 16 made of a resin material or the like, and simultaneously moves both the functional components 20 in the longitudinal direction.

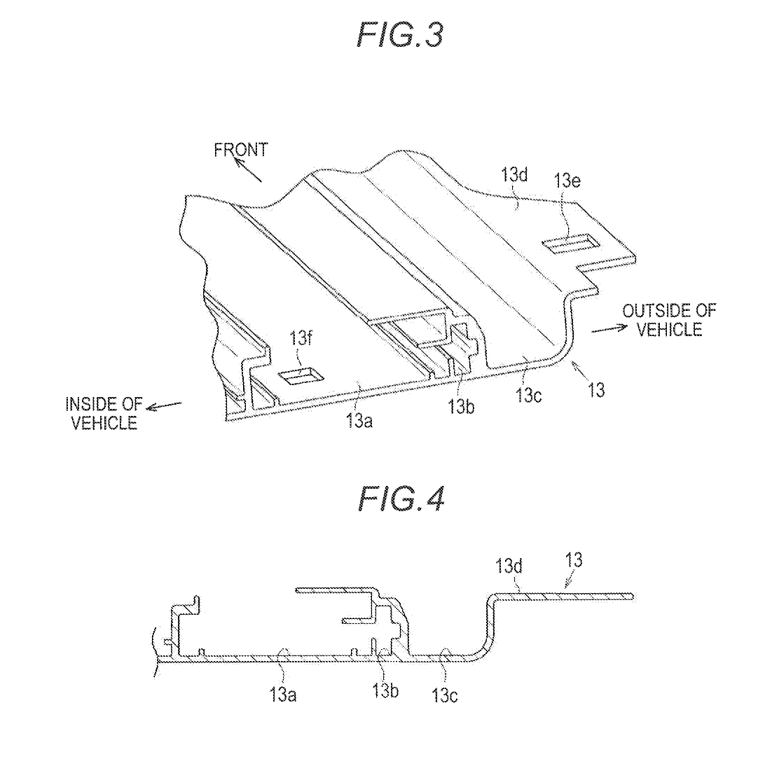

As illustrated in FIGS. 3 and 4, each of the guide rails 13 includes a first rail portion 13a which is formed in a substantially C-shaped section, and opens upward; a second rail portion 13b which is formed adjacent to a lateral outside portion of the first rail portion 13a; and a drain portion 13c which is formed in a substantially U-shaped section, and opens upward adjacent to a lateral outside portion of the second rail portion 13b.

The second rail portion 13b along with a side wall of the first rail portion 13a forms a substantially T-shaped section, and the second rail portion 13b communicates with the first rail portion 13a via an opening formed in the side wall. In contrast, the drain portion 13c is partitioned off by the second rail portion 13b in the lateral direction of the vehicle. The functional component 20 slides against the first rail portion 13a in the longitudinal direction, and the driving belt 16 slides against the second rail portion 13b in the longitudinal direction. The drain portion 13c runs in the longitudinal direction, receives water (for example, rain) falling from edge portions of the movable panel 12 in the lateral direction of the vehicle, and guides the water to the front end or the rear end of the drain portion 13c.

The guide rail 13 includes a flange-like attachment piece 13d that substantially horizontally extends from a lateral outside end of the drain portion 13c toward the outside of the vehicle. A substantially rectangular attachment hole 13e is formed in a rear end portion of the attachment piece 13d, and works as an engaging concave portion and an insertion hole which opens in the vertical direction of the vehicle. A substantially rectangular attachment hole 13f is formed in a rear end portion of a bottom wall of the first guide rail 13a, and works as an engaging concave portion and an insertion hole which opens in the vertical direction of the vehicle.

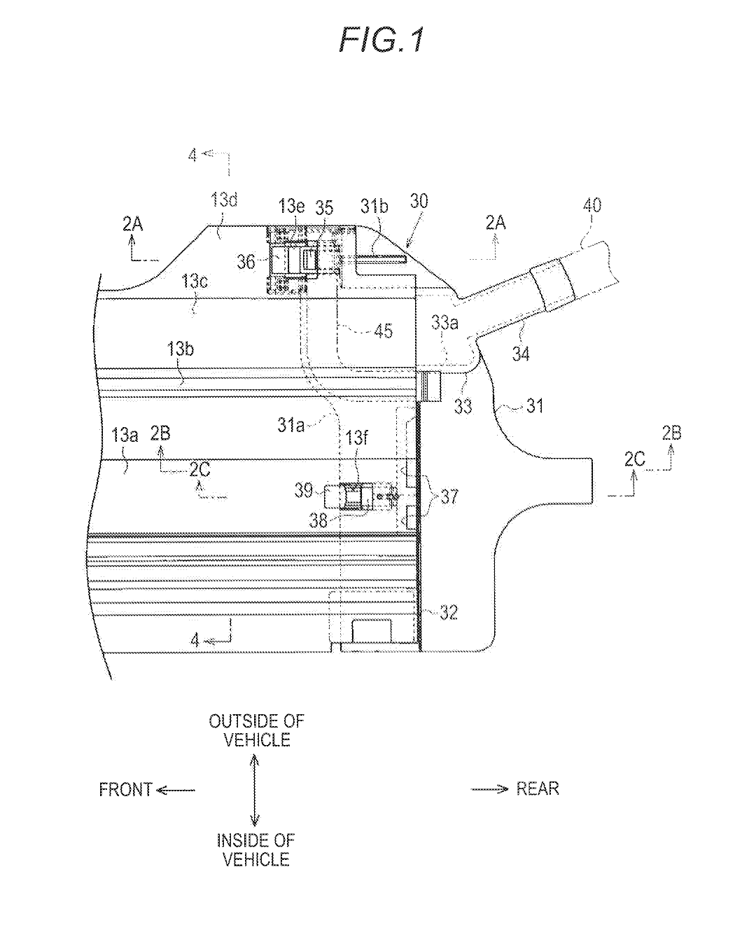

As illustrated in FIG. 1, a rear piece 30, made of a resin material or the like and working as a drain member, is mounted on a rear end portion of the guide rail 13. The rear piece 30 includes a base portion 31 that extends astride a rear end of the guide rail 13 in the longitudinal direction. A front end portion of the base portion 31 forms a bottom wall 31a as a lower wall, and the rear end portion of the guide rail 13 is mounted on the front end portion of the base portion 31. The bottom wall 31a is substantially in contact with the entire bottom surface of the guide rail 13 in the lateral direction of the vehicle. The rear piece 30 includes a substantially stripe-shaped rib 32 that is disposed closer to the inside of the vehicle than the drain portion 13c, and protrudes upward from the base portion 31. The rib 32 extends in the lateral direction of the vehicle, and is in contact with a rear end surface of the guide rail 13. The rear piece 30 includes a substantially box-like connection portion 33 that protrudes upward from the base portion 31 while being disposed at the position of the drain portion 13c in the lateral direction of the vehicle, and a substantially circular column-shaped hose opening 34 that is connected to a rear end of the connection portion 33. The connection portion 33 is substantially in contact with the entire rear end surface of the drain portion 13c, and forms a drain path 33a through which the drain portion 13c communicates with the hose opening 34. The connection portion 33 guides water (for example, rain), flowing through the drain portion 13c of the guide rail 13 toward the rear of the vehicle, to the hose opening 34 via the drain path 33a. A typical drain hose 40 is connected to the hose opening 34, and water (for example, rain), guided to the hose opening 34, is drained to the outside via the drain hose 40.

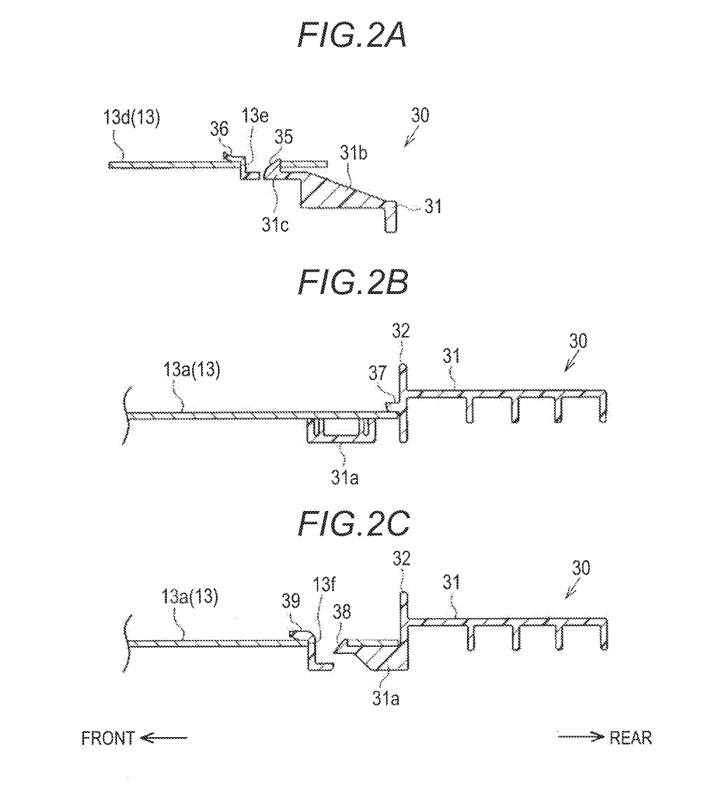

As illustrated in FIG. 2A, a protruding portion 31b and an extending piece 31c are formed closer to the outside of the vehicle than the drain portion 13c of the base portion 31. The protruding portion 31b protrudes high toward the upper side of the attachment piece 13d from a bottom wall of the drain portion 13c, and the extending piece 31c extends toward the front of the vehicle from a front end of the protruding portion 31b along the lower surface of the attachment piece 13d. An engaging convex portion 35 with the shape of a substantially triangle claw is formed in the rear piece 30 such that the engaging convex portion 35 protrudes upward from a front end portion of the extending piece 31c, and is engaged into the attachment hole 13e. A rear end surface of the engaging convex portion 35 is in contact with, or is positioned close to a facing inner wall surface of the attachment hole 13e, and thus the engaging convex portion 35 restricts the rear piece 30 from moving toward the rear of the vehicle relative to the guide rail 13.

A protruding piece 36, working as both an upper wall and a second protruding piece, is formed in the rear piece 30 such that the protruding piece 36 protrudes from the bottom wall 31a while being positioned in front of the engaging convex portion 35 in the vehicle, and is inserted into the attachment hole 13e, and the tip end of the protruding piece 36 passes through the attachment hole 13e, and extends toward the front of the vehicle farther than the attachment hole 13e. The attachment piece 13d (the guide rail 13) is interposed between the protruding piece 36 and the bottom wall 31a in the vertical direction of the vehicle, and thus the protruding piece 36 along with the bottom wall 31a restricts the rear piece 30 from moving relative to the guide rail 13 in the vertical direction of the vehicle.

As illustrated in FIG. 2B, a substantially visor-like protruding piece 37, working as an upper wall, is formed in the rear piece 30, and extends along the upper surface of the bottom wall of the guide rail 13 (the first rail portion 13a) toward the front of the vehicle from the rib 32 positioned at the rear end of the guide rail 13. A rear end portion of the bottom wall of the guide rail 13 is interposed between the protruding piece 37 and the bottom wall 31a in the vertical direction of the vehicle, and thus the protruding piece 37 along with the bottom wall 31a restricts the rear piece 30 from moving relative to the guide rail 13 in the vertical direction of the vehicle. As illustrated in FIG. 1, a plurality (two) of the protruding pieces 37 are formed in such a manner as to line up with each other in the lateral direction of the vehicle.

As illustrated in FIG. 2C, an engaging convex portion 38 with the shape of a substantially triangle claw is formed in the rear piece 30 such that the engaging convex portion 38 protrudes upward from the bottom wall 31a, and is engaged into the attachment hole 13f. A rear end surface of the engaging convex portion 38 is in contact with, or is positioned close to a facing inner wall surface of the attachment hole 13f, and thus the engaging convex portion 38 restricts the rear piece 30 from moving toward the rear of the vehicle relative to the guide rail 13.

A protruding piece 39, working as both an upper wall and a second protruding piece, is formed in the rear piece 30 such that the protruding piece 39 protrudes from the bottom wall 31a while being positioned in front of the engaging convex portion 38 in the vehicle, and is inserted into the attachment hole 13f, and the tip end of the protruding piece 39 passes through the attachment hole 13f, and extends toward the front of the vehicle farther than the attachment hole 13f. The bottom wall of the first rail portion 13a (the guide rail 13) is interposed between the protruding piece 39 and the bottom wall 31a in the vertical direction of the vehicle, and thus the protruding piece 39 along with the bottom wall 31a restricts the rear piece 30 from moving relative to the guide rail 13 in the vertical direction of the vehicle.

As illustrated in FIG. 1, a substantially tape-like seal member 45 made of an elastic material or the like stick to the lower surface of the guide rail 13. The seal member 45 extends astride the attachment piece 13d, the drain portion 13c, and the second rail portion 13b in the lateral direction of the vehicle, is oriented toward the rear of the vehicle, and extends along the second rail portion 13b further toward the rear of the vehicle than the rear end of the guide rail 13. As described above, since the rib 32 is positioned at the rear end of the guide rail 13, the seal member 45 extends upward while being interposed between the rear end surface of the guide rail 13 and the rib 32, and is oriented downward from an upper end of the rib 32. Accordingly, water is prevented from infiltrating a region on the lower surface of the guide rail 13, with the region being positioned closer to the front of the vehicle and the inside of the vehicle than the rear end of the drain portion 13c.

Subsequently, an operation of the embodiment is described.

Since the rear piece 30 (the rib 32 and the like) is in contact with the rear end of the guide rail 13, the rear piece 30 is restricted from moving toward the front of the vehicle relative to the guide rail 13, and since the guide rail 13 is interposed between the protruding pieces 36, 37, and 39 and the bottom wall 31a in the vertical direction of the vehicle, the rear piece 30 is restricted from moving relative to the guide rail 13 in the vertical direction of the vehicle. Since the engaging convex portions 35 and 38 are respectively engaged into the attachment holes 13e and 13f, the rear piece 30 is restricted from moving toward the rear of the vehicle relative to the guide rail 13. The protruding pieces 36 and 39 restrict the rear piece 30 from moving toward the front of the vehicle relative to the guide rail 13, with the protruding pieces 36 and 39 being respectively inserted into the attachment holes 13e and 13f.

When an operator assembles the rear piece 30 to the guide rail 13, the operator assembles the rear piece 30 in such a manner that the rear piece 30 approaches the guide rail 13 from below the guide rail 13 while the rear piece 30 is slightly offset toward the rear of the vehicle relative to the guide rail 13, inserts the protruding pieces 36 and 39 into the attachment holes 13e and 13f, and lightly hooks the protruding pieces 36 and 39 onto the front edge portions of the 13e and 13f, respectively. In this state, the operator holds the rear piece 30 upward, and moves the rear piece 30 toward the front of the vehicle. As a result, the protruding piece 37 advances toward the front of the vehicle more than the rear end of the guide rail 13, and the engaging convex portions 35 and 38 reach and are engaged into the attachment holes 13e and 13f, respectively. As such, the assembly of the rear piece 30 to the guide rail 13 is completed.

As described above in detail, in the embodiment, it is possible to obtain the following effects.

(1) In the embodiment, it is possible to fix the rear piece 30 to the guide rail 13 without a separate component (for example, screws) (required in the related art) being added or an attachment tool being used, and it is possible to reduce the number of components and manufacturing man hours. In addition, it is possible to reduce costs.

(2) In the embodiment, the guide rail 13 can be interposed between the bottom wall 31a and the protruding piece 37 in the vertical direction of the vehicle while the rear end of the guide rail 13 is used without the guide rail 13 being machined.

(3) In the embodiment, the guide rail 13 can be interposed between the protruding pieces 36 and 39 and the bottom wall 31a in the vertical direction of the vehicle at the longitudinal positions of the attachment holes 13e and 13f, and it is possible to improve the degree of freedom in determining the position in which the guide rail 13 can be interposed between the protruding pieces 36 and 39 and the bottom wall 31a.

The embodiment may be changed in the following manner.

In the embodiment, the number of protruding pieces 37 may be one, or may be three or more and the protruding pieces 37 may line up with each other in the lateral direction of the vehicle.

In the embodiment, a substantially visor-like lower wall may extend toward the front of the vehicle from a portion of the rear piece 30 along the lower surface of the bottom wall of the guide rail 13 (the first rail portion 13a), with the portion of the rear piece 30 being positioned at the rear end of the guide rail 13, and the guide rail 13 may be interposed between the lower wall and the protruding piece 37 in the vertical direction of the vehicle. In this case, the lower wall and the protruding piece 37 may be disposed at different positions in the lateral direction of the vehicle, and the lower wall may be disposed in such a manner that a portion or the entirety of the lower wall overlaps the protruding piece 37 in the lateral direction of the vehicle.

In the embodiment, three or more pairs of the second protruding pieces (36, 39) and the insertion holes (13e, 13f), into which the second protruding pieces (36, 39) are respectively inserted, may be provided.

In the embodiment, at least one of the protruding pieces 36, 37, and 39 may be provided.

In the embodiment, the engaging convex portions 35 and 38 are respectively engaged into the attachment holes 13e and 13f into which the protruding pieces 36 and 39 are inserted. In contrast, the engaging convex portions (35, 38) may be respectively engaged into adequate engaging concave portions which are formed separate from the attachment holes 13e and 13f in the guide rail 13. In this case, these engaging concave portions may pass through the guide rail 13 in the vertical direction of the vehicle, or may be non-through holes which are concave upward from the lower surface of the guide rail 13.

In the embodiment, the engaging convex portions (35, 38) may protrude downward from the base portion 31, and may be respectively engaged into the attachment holes 13e and 13f. These engaging convex portions may be respectively engaged into adequate engaging concave portions which are formed separate from the attachment holes 13e and 13f in the guide rail 13. In this case, these engaging concave portions may pass through the guide rail 13 in the vertical direction of the vehicle, or may be non-through holes which are concave downward from the upper surface of the guide rail 13.

In the embodiment, the attachment holes 13e and 13f (engaging concave portions) are formed in the guide rail 13, and the engaging convex portions 35 and 38 are formed in the rear piece 30; however, the engaging concave portions and the engaging convex portions may be formed the other way around. That is, the engaging convex portions may be formed in the guide rail 13, and the engaging concave portions may be formed in the rear piece 30.

A sunroof drain device according to an aspect of this disclosure includes a guide rail in which a drain portion is formed running in a longitudinal direction of a vehicle, and extends in the longitudinal direction; and a drain member which is disposed while being in contact with a rear end of the guide rail, in which an upper wall and a lower wall are formed with the guide rail interposed therebetween in a vertical direction of the vehicle, and through which the drain portion is connected to a drain hose, in which an engaging concave portion is formed in one of the guide rail and the drain member, and is concave in the vertical direction of the vehicle, and in which an engaging convex portion is formed in the other of the guide rail and the drain member, protrudes in the vertical direction of the vehicle, and is engaged into the engaging concave portion such that the engaging convex portion restricts the drain member from moving toward the rear of the vehicle relative to the guide rail.

In this configuration, since the drain member is in contact with the rear end of the guide rail, the drain member is restricted from moving toward the front of the vehicle relative to the guide rail, and since the guide rail is interposed between the upper wall and the lower wall in the vertical direction of the vehicle, the drain member is restricted from moving relative to the guide rail in the vertical direction of the vehicle. Since the engaging convex portion is engaged into the engaging concave portion, the drain member is restricted from moving toward the rear of the vehicle relative to the guide rail. As such, it is possible to fix the drain member to the guide rail without a separate component (for example, screws) being added, and it is possible to reduce the number of components.

In the sunroof drain device, it is preferable that the lower wall is a bottom wall on which the guide rail is mounted, and the upper wall is a protruding piece that extends toward the front of the vehicle from the rear end of the guide rail.

In this configuration, the guide rail can be interposed between the upper wall and the lower wall in the vertical direction of the vehicle while the rear end of the guide rail is used without the guide rail being machined.

In the sunroof drain device, it is preferable that an insertion hole is formed in the guide rail, and opens in the vertical direction of the vehicle, the lower wall is a bottom wall on which the guide rail is mounted, and the upper wall is a second protruding piece which protrudes from the bottom wall, and is inserted into the insertion hole, and the tip end of which passes through the insertion hole, and extends toward the front of the vehicle farther than the insertion hole.

In this configuration, the guide rail can be interposed between the upper wall and the lower wall in the vertical direction of the vehicle at the position of the insertion hole in the longitudinal direction of the vehicle, and it is possible to improve the degree of freedom in determining the position in which the guide rail is interposed between the upper wall and the lower wall.

In the sunroof drain device, it is preferable that the engaging concave portion passes through the guide rail or the drain member in the vertical direction of the vehicle.

According to the aspect of this disclosure, it is possible to prevent an increase in the number of components.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A sunroof drain device comprising:
a guide rail in which a drain portion is formed running in a longitudinal direction of a vehicle, and extends in the longitudinal direction; and
a drain member which is disposed while being in contact with a rear end of the guide rail, in which an upper wall and a lower wall are formed with the guide rail interposed therebetween in a vertical direction of the vehicle, and through which the drain portion is connected to a drain hose, wherein
an engaging concave portion is formed in one of the guide rail and the drain member, and is concave in the vertical direction of the vehicle, and
an engaging convex portion is formed in the other of the guide rail and the drain member, protrudes in the vertical direction of the vehicle, and is engaged into the engaging concave portion such that the engaging convex portion restricts the drain member from moving toward the rear of the vehicle relative to the guide rail.

2. The sunroof drain device according to claim 1, wherein
the lower wall is a bottom wall on which the guide rail is mounted, and
the upper wall is a protruding piece that extends toward the front of the vehicle from the rear end of the guide rail.

3. The sunroof drain device according to claim 1, wherein
an insertion hole is formed in the guide rail, and opens in the vertical direction of the vehicle,
the lower wall is a bottom wall on which the guide rail is mounted, and
the upper wall is a second protruding piece which protrudes from the bottom wall, and is inserted into the insertion hole, and the tip end of which passes through the insertion hole, and extends toward the front of the vehicle farther than the insertion hole.

4. The sunroof drain device according to claim 1,
wherein the engaging concave portion passes through the guide rail or the drain member in the vertical direction of the vehicle.
